(19) United States
(12) Patent Application Publication
(10) Pub. No.: US 2013/0207876 A1
(43) Pub. Date: Aug. 15, 2013

(54) ADAPTABLE VEHICULAR FILM ANTENNA

(71) Applicants: Bernd SCHWARZ, Walddorf-Haeslach (DE); Ingmar Petersen, Esslingen (DE); Markus PFLETSCHINGER, Eningen (DE)

(72) Inventors: Bernd SCHWARZ, Walddorf-Haeslach (DE); Ingmar Petersen, Esslingen (DE); Markus PFLETSCHINGER, Eningen (DE)

(21) Appl. No.: 13/758,737

(22) Filed: Feb. 4, 2013

(30) Foreign Application Priority Data
Feb. 7, 2012 (DE) 102012002180.1

(51) Int. Cl. H01Q 21/00; H01P 11/00

(52) U.S. Cl. CPC H01Q 21/00; H01P 11/001
USPC 343/879; 29/600

(57) ABSTRACT

An antenna has a flat support having two sections. Antenna structures carried on the support sections. A joint between the connections allows the two sections to be pivoted relative to each other.

### CROSS REFERENCE TO RELATED APPLICATION

This application claims the priority of German patent application 10 2012 008 180.1 filed 7 Feb. 2012.

### FIELD OF THE INVENTION

The invention relates to an antenna having a flat support having at least one antenna structure connected to an antenna cable or an amplifier, as well as a method of installing such an antenna having a flat support carrying has at least one antenna structure connected to an antenna cable.

### BACKGROUND OF THE INVENTION

Vehicles having an antenna are generally known. Such antennas are, for example, rod antennas or antenna structures integrated into the vehicle windows. These antennas are already is built in during the manufacture of the vehicle; however, the present invention does not deal such antennas as original equipment.

A field-upgradable antenna, particularly for vehicles, is intended to be provided on a vehicle component that passes high-frequency signals. These are generally vehicle windows, particularly rear windows of vehicles.

Such antennas that can be mounted after manufacture are usually adhered in the window in order to receive broadcast signals. Typically, wires or flexible boards with antenna structures on them are used as antennas.

One example of this is the TMC aerial antenna of navigation systems for receiving the RDS signals in the FM band. These aerial antennas are composed of a wire that is mounted on the window by suction cups.

In contrast, active antennas for receiving broadcasting and/or television signals in vehicles are less common. These antenna structures are usually carried on a circuit board. Depending on the frequency to be received, antenna structures that are more conductive or less conductive must be employed. They are then used, for example, to receive AM, FM, and TV signals and the like. Moreover, they can be used to receive signals for radio-controlled central locking or digital audio broadcasting (DAB). Such retrofitted antennas are usually not easy to install. They also often mar the exterior appearance of the vehicle.

### OBJECT OF THE INVENTION

It is therefore the object of the invention to provide an antenna, particularly for vehicles, as well as a method of installing such an antenna with which it is possible to subsequently install such antennas, particularly in vehicles. In particular, the intention is to make it possible to receive different antenna signals, particularly of different modulation types or in different frequency bands, using such an antenna.

### SUMMARY OF THE INVENTION

With respect to the antenna, according to the invention the support has two support sections extending at an angle α relative to each other, an antenna structure being provided on each support section. With a support that is angled in this way, the antenna can preferably be provided on a window, especially preferably a rear window, of a vehicle such that the view toward the outside, particularly the view in the rearward direction, is not obstructed. What is more, good reception, which is to say at least satisfactory antenna performance, is ensured if an independent antenna structure is provided on each support section. Advantageously, the two antenna structures provided on the support sections differ from one another, thus ensuring, for example, good reception of FM and TV signals. If more than one such antenna is used, it can form a diversity system for receiving broadcast signals or for other frequency bands or services. By virtue of the arrangement of the two support sections at a certain, presettable angle α relative to each other, it is possible to install the antenna in nearly any vehicle, advantageously in nearly any passenger car.

In a modification of the invention, provision is made that the angle α between the two support sections is fixed and is between 60° and 120°, especially preferably between 80° and 115°. By appropriate selection of the angle between the two support sections, the antenna according to the invention can be installed in any vehicle, preferably in any rear window, since such vehicles and their windows, particularly their rear windows, have different corner angles.

In a preferred embodiment of the invention, the two support sections are connected to each other via a joint, so that the angle α between the two support sections can be adjusted as desired. This embodiment offers the advantage that the angle between the two support sections can be customized. Once it has been established, such an antenna can be installed permanently in the vehicle, particularly on the window. As a result of this flexibility in the orientation of the two support sections that are adjustable relative to each other, the number of models is reduced compared to the embodiment in which the two support sections extend at a predetermined fixed certain angle relative to each other. The fixing of the two support sections relative to each other is then done by installation in the vehicle, particularly by orienting the two support sections at the desired angle to each other by moving them about the joint. Next, they are permanently mounted in the vehicle, preferably on the window, using suitable means, particularly by means of an adhesive. Moreover, the connection of the two support sections via an appropriately designed joint offers the advantage that they are already preconfigured as an antenna and each support section carries the required antenna structure.

In another alternative embodiment of the invention, provision is made that the two support sections can be connected to each other at a preset angle α. In such a case, for example, two separate support sections can be made with their antenna structures. After that, first one support section is mounted in the vehicle and then the second support section is mounted adjacent it, thus realizing the desired antenna for receiving different high-frequency signals. The arrangement in the vehicle of the two is support sections designed separately from each other can be done using an adhesive or the like. There is also the possibility of designing the two support sections as one structure, the desired angle α being realized by an appropriate shaping process such as, for example, bending at a certain angle. For example, to do this, appropriate markings can be present on the two support sections embodied in a single piece so that a user knows in what region or even in what regions he must perform at least one fold (or even several). Once this has been done, the appropriately designed antenna can be mounted in the vehicle with its support sections that now extend at a preset angle to each other. Such a procedure is ideal especially if the flat support and the two support sections are made of a very thin, workable material (such as a plastic film, for example).

As regards the variants described above for the design of the support with its support sections embodied either in a single piece or as two separate support sections, it is advantageous for the support to be formed from dielectrically. This can be a rigid or a flexible support such as a board (rigid) or a film (flexible), for example. It is also conceivable for the support to be transparent or not, depending on the specific application.

In one embodiment of the invention, antenna electronics are provided on at least one of the two support sections, the antenna cable and the at least one antenna structure being electrically connected to the antenna electronics. This offers the advantage that such an antenna can be an active antenna. For this purpose, the at least one antenna structure of each support section is connected to the at least one set of antenna electronics. Advantageously, only one set of antenna electronics, which are connected to the associated antenna structures on the two support sections, is present per antenna. However, it is also conceivable for a separate set of antenna electronics to be provided for each support section. Although this involves greater material and mounting expense, it is also possible for a separate set of antenna electronics to be present for each antenna structure and support section if two or more antenna structures are present on at least one of the two support sections. The antenna electronics are a matching network or an amplifier or a filter or a combination thereof, or the like. To supply these antenna electronics with power, a separate power supply cable can be provided.

Alternatively, it is conceivable for the antenna electronics to be provided with phantom powering via the antenna cable over which the high-frequency signals are also transmitted. In order to transmit the high-frequency signals received by the antenna structures, these antenna structures are connected at their base either directly to an antenna cable or to the antenna electronics. If the bases of the antenna structures are connected to the antenna electronics, the antenna electronics, in turn, have an output to which an antenna cable is connected or can be connected via a plug connection. It is thus possible to emit the received high-frequency signals, which are also optionally already processed by the antenna electronics, to downstream electronic units (such as an automobile radio, a navigation system or the like).

In a further embodiment of the invention, the flat support, particularly one or both support sections, has an adhesive layer. This adhesive layer can be covered by a protective film before installation of the antenna on the vehicle component. Advantageously, with an adhesive layer it is possible to permanently mount the antenna quickly and easily on the target component, particularly the window of the vehicle. The design of the flat support in the form of a plastic film with antenna structures provided thereupon and the arrangement of the adhesive layer on one side offers the advantage that such an antenna can be mounted on the target component of the vehicle in a very quick and uncomplicated manner.

The method according to the invention for mounting an antenna is characterized in that the support has two support sections extending at an angle α relative to each other, with one antenna structure is provided on each support section and the support sections being mounted to a target component in a final mounting position. This means that such an antenna, optionally with antenna electronics, can be manufacture such that the two support sections extend at the desired angle relative to each other. As already described above, this angle is either fixed or variable. An antenna made in such a way can be mounted easily and quickly on the target component of the vehicle. After that, it is only necessary to route the antenna cable and connect it to a downstream electronic device.

In a further embodiment of the invention, an initially set angle α between the two support sections is changed in the antenna from a first, preset angle to another angle, the other angle corresponding to the angle at which the two support sections are intended to form when applied to the target component in the final mounting position. This offers the advantage that the antenna, more specifically its two support sections, are first in a preinstallation position (which can also be referred to as the delivery position). In the case of elongated support sections, they extend nearly parallel to each other in order to save space. When the antenna is to be mounted on the target component, the two is support sections are oriented relative to each other (for example, through rotation about a joint, folding, bending or the like) such that the angle is set which corresponds to the final mounting angle on the target component. After that, the antenna prepared in this way can be permanently fixed on the target component.

In a further embodiment of the invention, provision is made that the support, particularly at least one support section, more particularly both support sections, have an adhesive layer with which the support is adhered to the target component. For this purpose, provision is made that the at least one adhesive layer is covered by a stripoff film as long as the antenna is still in the preinstallation position or delivery position. Only shortly before adhesion of the antenna is the stripoff film (protective film) pulled off so that the prepared antenna can be adhered to the target component.

### BRIEF DESCRIPTION OF THE DRAWING

The antenna according to the invention as well as the corresponding method of installing such an antenna are explained in further detail below with reference to the figures, in which:

FIG. 1 is a perspective view of a first embodiment of the invention;

FIG. 2 is an elevational view of the first embodiment;

FIG. 3 is an elevational view of a second embodiment;

FIG. 4 is an elevational view showing two of the first embodiments mounted on a windshield;

FIG. 5 is an elevational view of a third embodiment;

FIG. 6 is a large-scale view of a detail of the third embodiment;

FIG. 7 is a view of the third embodiment in the preinstallation position or state;

FIG. 8 shows the third embodiment as it is being opened; and

FIG. 9 shows the third embodiment in two different positions.

### DETAILED DESCRIPTION

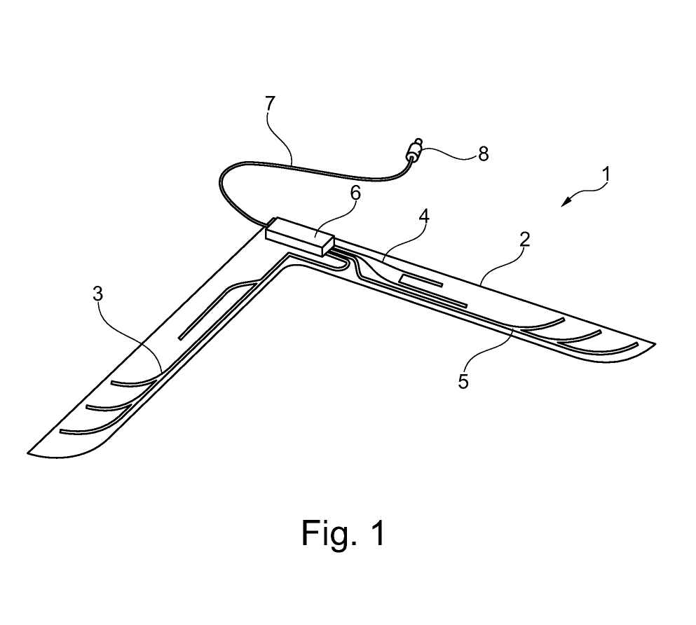

FIG. 1 shows, as shown in detail, a first embodiment of an antenna 1. This antenna 1 has a flat support 2. The support 2 is, for example, a board (rigid) or a film, particularly a plastic film (flexible). The support 2 has two support sections 2.1 and 2.2 extending at an angle to each other. The support sections 2.1 and 2.2 are elongated and carry antenna structures 3, 4, 5. These antenna structures 3 to 5 are used to receive high-frequency signals, at least two antenna structures (here 4 and 5, for example) that differ from one another and are designed to receive different services (such as television and radio, for example) or to receive high-frequency signals in different frequency ranges. Moreover, the antenna 1 comprises antenna electronics 6, an antenna cable 7 and, at the end thereof, a plug connector 8. The antenna electronics 6 can be present in principle but need not be. If the antenna electronics 6 are provided, the antenna structures 3 to 5 (or also only two antenna structures or more than three antenna structures) extend at their bases into the region of the antenna electronics 6 and are connected there electronically. On the output side, the antenna electronics 6 are connected to an antenna cable 7 over which the received high-frequency signals are transmitted to a downstream electronic unit (not shown here). For this purpose, the plug connector 8 is present with which the antenna electronics 6 can be connected to this unit via the antenna cable 7. The antenna cable 7 is therefore connected directly to the at least one antenna structure or indirectly via the antenna electronics (for example an amplifier) to the at least one antenna structure.

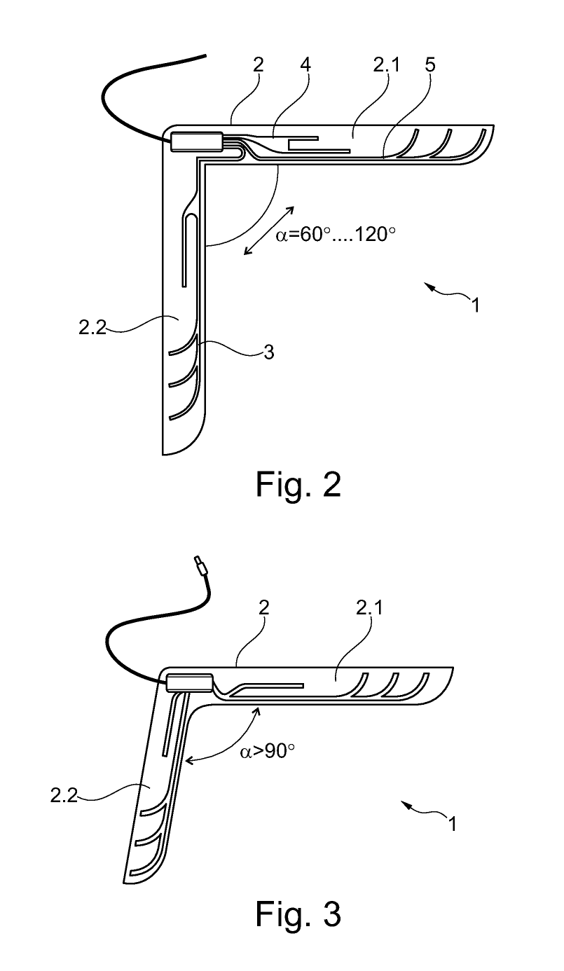

In order to more precisely illustrate the invention, FIG. 2 shows that the support 2 has the two support sections 2.1 and 2.2 that extend at an angle α relative to each other. In this embodiment, exactly as in the embodiment according to FIG. 3, the angle between the two support sections 2.1 and 2.2 is fixed and cannot be changed. To achieve the desired flexibility during mounting of the antenna 1 on a target component of the vehicle, particularly a window, the two support sections 2.1 and 2.2 are oriented at an angle α relative to each other of between 60° and 120°. Preferably, this angle is between 90° and 115°, since all regions of the target component and its geometric structure can be covered using such angle ranges. FIGS. 2 and 3 also show again that, for example, the antenna structure 3 on the support section 2.2 constitutes an FM antenna, whereas the antenna structure 4 on the support section 2.2 is a TV antenna. The antenna structure 3 is also formed once again as an antenna structure 5 in the same way on the support section 2.1. Here, it is conceivable for the antenna structure 4 to be provided not only on the support section 2.1 but again on the support section 2.2 as well. Depending on the number and geometry of the respective antenna structures, antenna performance can be improved or a diversity system can be made. FIG. 3 shows for the sake of completeness that the two support sections 2.1 and 2.2 are oriented at an angle αrelative to each other that is greater than 90°.

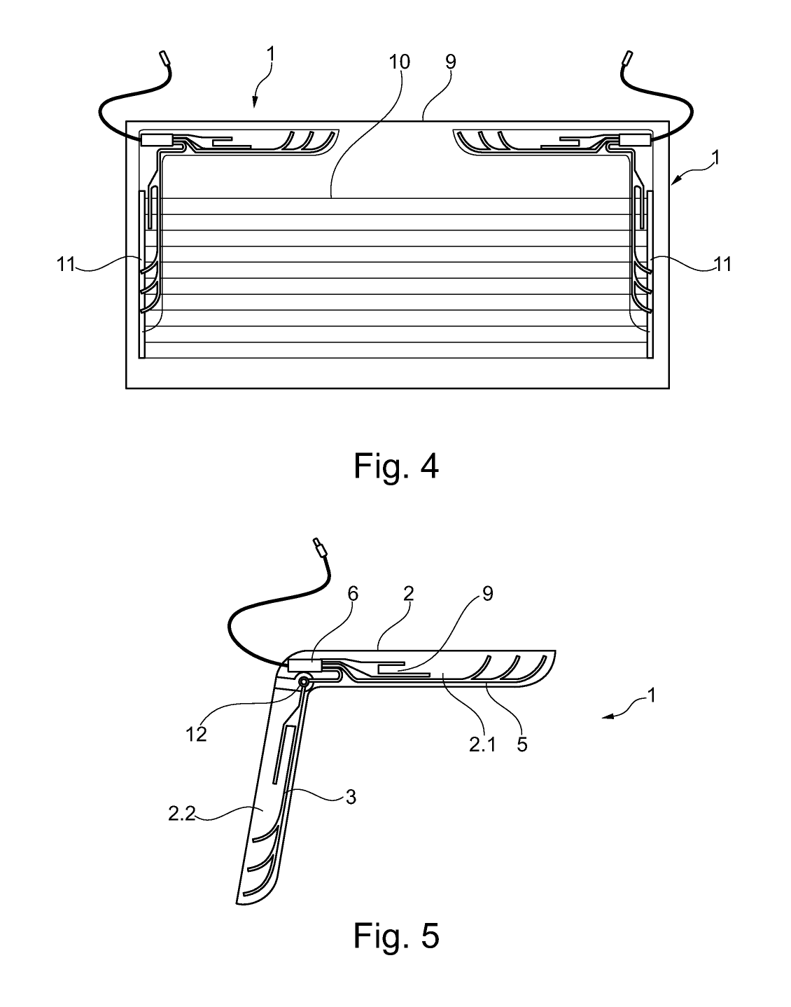

FIG. 4 shows that the target component on which the antenna 1 is to be provided is, for example, a rear window 9 of a vehicle. In this case, the rear window 9 has several heat elements 10 running parallel to each other with associated connection lines 11, thus realizing a rear window defroster known per se. As shown in FIG. 1, an independent antenna 1 is present in each of the two upper corners of the rear window 9. The two separate antenna structures (for FM and TV, for example) of the two antennas 1 mounted to the right and the left of the rear window 9 thus provide for good reception of high-frequency signals. The installation of the antennas 1 on the rear window is the best place for achieving the desired antenna performance. Moreover, by virtue of the four antenna structures 3, 5 (i.e. the fact that there are a total of four FM antennas present) makes possible a diversity system. It is clear here that the two antennas 1 can be adhered to the rear window 9 in the simplest manner from the inside with their respective supports 2 (formed by the two support sections 2.1 and 2.2). In order to prevent unnecessary cable clutter, the two signals of the antenna structures 3, 5 or 4 are fed together via the antenna cable 7 (high-frequency coaxial cable) to the downstream electronic device (particularly a tuner), where the incoming FM/TV signals are split again. In addition, phantom powering can be used for the antenna electronics 6, thus eliminating an additional cable for supplying the antenna electronics 6, particularly the amplifier, with power. While FIG. 4 shows that two mutually separate antennas 1 are mounted in the two upper corners of the rear window 9, it is of course also possible to provide only one antenna 1 or even more than two antennas 1 in the rear window 9 (or on any other target component of the vehicle).

The antenna shown in FIG. 5 is primarily based on the design of the antenna 1 as shown in FIG. 1. The substantial difference is that the two support sections 2.1 and 2.2 are formed as mutually separate support sections and are connected together via a joint 12. This joint 12 can be embodied in a number of ways. For one, it must assume the task of connecting the two support sections 2.1 and 2.2 to each other and, simultaneously, be able to set the desired angle α between the two support sections. This means that the joint first assumes a purely mechanical task.

Moreover, it can, but need not, perform an electrical function. This is necessary if the sole set of antenna electronics 6 is provided on one support section (here 2.1) and it is necessary to electrically connect the antenna structure 3 of the second support section 2.2 to the antenna electronics on the first support section 2.1. In this case, the joint 12 has not only a mechanical but also an electrical function. The base of the antenna structure 3 is therefore connected to the antenna electronics 6 via the joint 12. Such an electronic function of the joint 12 can be omitted if an independent set of antenna electronics 6 is present on each support section 2.1 and 2.2, in which case a respective set of antenna electronics 6 must be connected to its antenna structures on its support section. Moreover, in the event that a single set of antenna electronics is provided on one support section and more than one antenna structure is provided on the other support section movable in relation thereto, measures must be taken to ensure that (as shown in FIG. 5) one antenna structure is electrically connected to the antenna electronics 6 via the joint 12 and, at the same time, the at least one other antenna structure is also electrically connected to the antenna electronics on the other support section via another transmission link. In such a case, transmission can take place, for example, as a result of the two support sections 2.1 and 2.2 first being stretched longitudinally. The antenna electronics 6 are then mounted on the support 2 and connected to the base points of the antenna structures. Only after that are the two support sections 2.1 and 2.2 oriented at the desired angle α relative to each other by bending the two support sections 2.1 and 2.2 along at least one line. This embodiment can be realized especially easily if the support 2 is a plastic film and the antenna structures on the plastic film are of an electrically conductive material, particularly printed on. In this way, the desired geometries of the antenna structures can be achieved and their bases can end in a common region in which the antenna electronics are then placed onto the support. Next, the two support sections 2.1 and 2.2 are oriented at the desired angle a through shaping (such as bending, folding or the like) and then the antenna electronics 6 are mounted or the antenna electronics 6 are first mounted and then shaped.

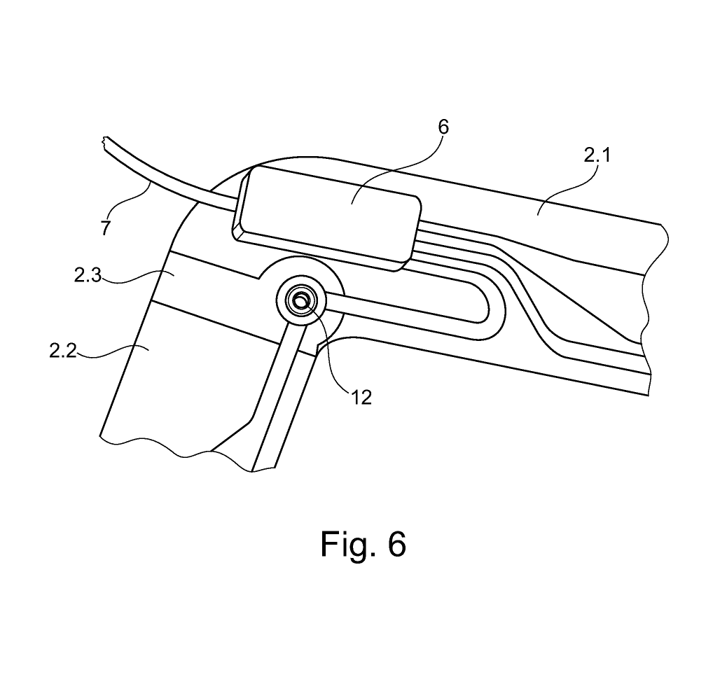

FIG. 6 shows the embodiment according to FIG. 5 again in detail, with it being visible that the two ends of the support sections 2.1 and 2.2 are connected to each other via the joint 12. Here, too, the joint 12 can but need not assume not only a purely mechanical function but also an electrical connection function as well. It is also visible that the ends of the two support sections 2.1 and 2.2 overlap in an overlap region 2.3. This overlap region 2.3 changes depending on the angle α at which the two support sections 2.1 and 2.2 are oriented relative to each other. The joint 12, particularly embodied as a pivot joint, can be realized, for example, with the aid of a rivet that is electrically insulated so that no contact can occur to a heating element on the rear window or to other regions of the target component. This effectively prevents a short circuit. Alternatively, the pivot 12 can be embodied as a push button (similarly as in a 9 volt block battery). While it is shown in FIGS. 5 and 6 that the pivot 12 is provided outside the antenna electronics (more precisely, outside its housing), it is of course also conceivable for the pivot to be located in the region of the housing of the antenna electronics 6. This offers the advantage that it can be optimally electrically insulated by this housing of the antenna electronics 6. Other embodiments of a pivot 12 are conceivable, although it must be ensured that the overall height of the pivot 12 is quite small, since the flat support 2 is made of components having a very small overall thickness (particularly in the 1-digit millimeter range or even smaller). In particular, the overall height of the pivot 12 on the side of the support 2 should not extend beyond the overall thickness of the antenna electronics 6.

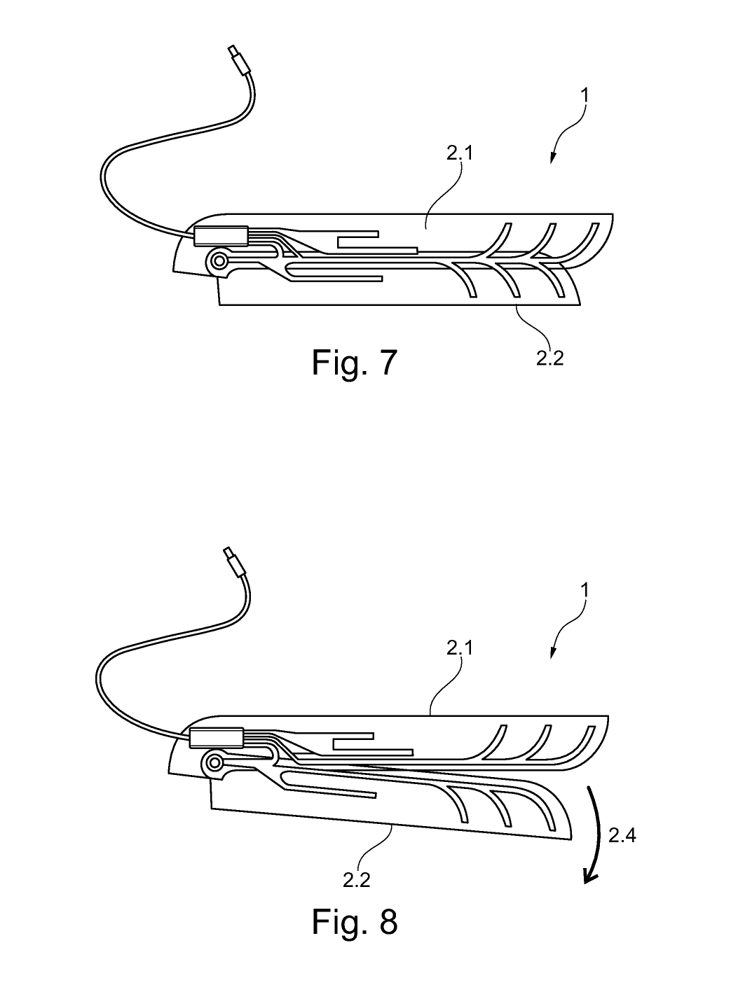

The method according to the invention for mounting the antenna 1, as shown in the preceding figures, follows from FIGS. 7 to 9. In FIG. 7, the original state of the antenna 1 can be seen after its manufacture. This is the packaged or delivered state. However, the two support sections 2.1 and 2.2 are moveable so as to be oriented in relation to each other. In the case of the sample embodiment according to FIG. 7, the pivot 12 is used for this. However, it is conceivable for the two support sections 2.1 and 2.2, which are embodied as separate components according to FIG. 7, to form a one-piece component so that the two support sections 2.1 and 2.2 lie on each other, for example by folding, in this alternative delivery state. Starting from the embodiment according to FIG. 7, to mount the antenna 1, the two support sections 2.1 and 2.2 can be pivoted in a direction of motion 2.4 about the pivot 12.

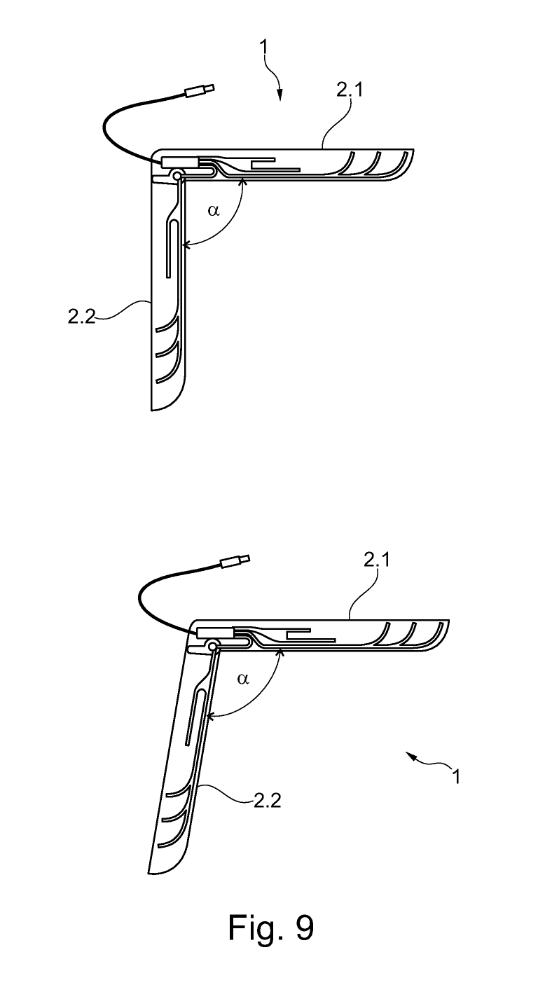

This pivoting in the direction of motion 2.4 occurs until the desired angle α has been set. In the left portion of FIG. 9, it is shown that, upon conclusion of the pivoting procedure, the two support sections 2.1 and 2.2 are oriented at the desired angle a relative to each other of 90°. The illustration on the right side of FIG. 9 shows an alternative orientation in which, upon conclusion of the pivoting procedure, an angle α equaling 115° has been set. These two different angles result from the geometry of the target component on which the antenna 1 is to be mounted. Not shown but present on the underside of one or both support sections 2.1 and 2.2 is an adhesive layer that is protected up to this point by a stripoff film. After the desired angle α has been set, this stripoff film can be pulled off and the antenna 1 can be adhered with its support sections 2.1 and 2.2 and the antenna structures located thereon to the target component. After that, all that is required is that the antenna 1 be connected at least with the antenna cable 7 (and, optionally, a power supply cable, if necessary) to a downstream electronic unit (not shown). To enable the set angle α to be held right before the adhering of the antenna to the target component, the pivot 12 is advantageously embodied such that it requires a certain amount of force to pivot the support section 2.2 in the direction of motion 2.4 relative to the support section 2.1 (see FIG. 8). Without this additional application of force, the pivot 12 is designed such that it holds the set position of the two support sections 2.1 and 2.2 relative to each other, so that the set angle α is held even after the mounting, particularly the adhering of the antenna 1 to the target component.

The same sequence of motion as is shown in FIGS. 7 to 9 in connection with the pivot 12 also applies analogously in the event that the support 2 is embodied in a single piece with its support sections 2.1 and 2.2 and the angle α between the two support sections 2.1 and 2.2 is set by folding or the like. Finally, it is also conceivable for the two support sections 2.1 and 2.2 to be mutually separate components that are joined together, for example adhered together, at the desired angle α. In that case, however, it must be kept in mind that the at least one antenna structure on one support section must also be electrically connected to the antenna electronics on the other support section.

With regard to the adhesive layer on the support 2, it should also be pointed out that it is advantageously applied over the entire surface of the support 2, or its support sections 2.1 and 2.2. Alternatively, it is conceivable for such an adhesive layer to only cover part. For instance, the adhesive layer can be applied nearly completely on the support section 2.1 and/or 2.2, with the exception of one end. However, the stripoff film (=protective film) for protecting the adhesive layer corresponds to the entire surface of the support 2 or of the support section 2.1 and/or 2.2, so that it is easier to pull off the stripoff film beginning at the end of a support section. The adhesive layer with the protective film can also be embodied as a two-sided adhesive tape. Advantageously, the adhesive layer is transparent so that vision is not impeded.

The two support sections (or only one) can also be oversized. To mount them, the excess portion must then be removed (for example cutting off a piece along a side edge parallel to it) so that the associated support section can be mounted at its installation location. This is preferably done by cutting off an optionally marked part of the support section, simply using scissors in the case of a film. This applies to all embodiments described in the foregoing and for only one support section or both.

1. An antenna comprising:
a flat support,
two antenna structure carried on the support,
an antenna cable connected to the antenna structures, the support having two support sections and each carrying a respective one of the antenna structures.

2. The antenna as set forth in claim 1, wherein the angle between the two support sections is fixed and is between 60° and 100°.

3. The antenna as set forth in claim 1, further comprising:
a joint connecting together the two support sections such that the angle can be varied.

4. The antenna as set forth in claim 1, wherein the two support sections are connected to one another at a presettable angle.

5. The antenna as set forth in claim 1, further comprising:
antenna electronics on at least one of the two support sections, the antenna cable and the at least one antenna structure being electrically connected to the antenna electronics.

6. The antenna as set forth in that claim 1, wherein at least one of the support sections, has an adhesive layer and a stripoff layer covering the adhesive layer before mounting of the antenna.

7. A method of installing an antenna, having a flat support carrying at least one antenna structure connected to an antenna cable, the support having two support sections extending at an angle relative to each other, the method comprising the steps of:
applying the support sections to a target component in a final mounting position.

8. The method as set forth in claim 7, further comprising the step of:
changing an angle between the two support sections is changed from a first angle to another angle, the other angle corresponding to the angle at which the two support sections are to be applied to the target component in the final mounting position relative to each other.

9. The method as set forth in one of claims 7, wherein at least one support sections, has an adhesive layer covered by a protective film before mounting of the antenna on the target component, the method further comprising the step of:
pulling off the and this protective film off shortly before the mounting the antenna on the target component.
